(19) United States
(12) Patent Application Publication
(10) Pub. No.: US 2018/0315568 A1
(43) Pub. Date: Nov. 1, 2018

(54) METHOD AND SYSTEM FOR DETECTING RELAY ADHESION

(71) Applicant: Contemporary Amperex Technology Co., Limited, Ningde City (CN)

(72) Inventors: Fei ZHAO, Ningde City (CN); Xing WU, Ningde City (CN); DeQing CHEN, Ningde City (CN)

(21) Appl. No.: 15/958,284

(22) Filed: Apr. 20, 2018

(30) Foreign Application Priority Data
Apr. 26, 2017 (CN) 201710281788.1

(51) Int. Cl. H01H 47/00; B60L 3/00; B60L 11/18; G08B 21/18

(52) U.S. Cl. CPC H01H 47/002; B60L 3/0046; B60L 11/1851; B60L 2250/10; H01H 2231/026; H01H 2239/044; H01H 2300/052; G08B 21/185

(57) ABSTRACT

A method and a system for detecting an adhesion of a relay are disclosed. In a high voltage circuit, a voltage is measured across a load multiple times within a specified time period when a first relay and a second relay are open and a third relay is closed, where the second relay may be a main negative relay of the high voltage circuit. The second relay is declared to have an adhesion malfunction when a change in the value of the measured load voltage satisfies a specified condition. Using the change in the sampled load voltages external to the main negative relay, the adhesion malfunction of the main negative relay may be diagnosed, so that corrective action may be taken. The potential safety hazard caused by the adhesion malfunction of the main negative relay may be prevented, such as may occur in an electric vehicle high voltage circuit.

### CROSS-REFERENCE TO RELATED APPLICATION(S)

This application claims the benefit of Chinese Patent Application No. CN201710281788.1, entitled “METHOD AND SYSTEM FOR DETECTING RELAY ADHESION” and filed on Apr. 26, 2017 in the State Intellectual Property Office of the People's Republic of China (PRC) (SIPO).

### BACKGROUND

### Field

The present invention relates to the field of circuit technology, and in particular to a method and system for detecting an adhesion of a relay.

### Background

Electric vehicles are powered by an on-board electrical power source. In particular, power is generated by a motor, and as such electrical vehicles have a much smaller negative impact on the environment than conventional vehicles. Therefore, electric vehicles have broad appeal.

Since an electric vehicle uses mainly electric energy, a high voltage circuit that provides power is an important part of an electric vehicle. The high voltage circuit may include a battery pack and one or more relays, including a main negative relay connected to the negative battery of the battery pack. When the high voltage circuit is working properly, people in the vehicle are kept safe from the high voltage.

Specifically, when the high voltage circuit is in working condition, if the vehicle is in a collision, the high voltage circuit is opened using the main negative relay to prevent the high voltage circuit from endangering the people in the vehicle. However, after prolonged use, the main negative relay may have a malfunction of adhesion, with the result that the high voltage circuit cannot be opened, thus posing a safety hazard to the people in the vehicle.

### SUMMARY

The present application discloses a method and a system for detecting an adhesion malfunction of a relay. The method and system disclosed may be used to prevent the potential safety hazard existing in the existing technology caused by the adhesion malfunction of the main negative relay of an electric vehicle high voltage circuit.

One or more embodiments of the present application provide a method for detecting an adhesion malfunction of a relay. The method may be applied to a high voltage circuit, where the high voltage circuit comprises a battery pack, a first relay, a load, and a second relay. The first relay is connected to a positive electrode of the battery pack, and the second relay is connected to a negative electrode of the battery pack. The high voltage circuit further includes a series branch formed by a third relay and a first resistor, where the series branch is connected in parallel with the first relay. The method includes measuring a second voltage across the load multiple times within a specified time period when the first relay and the second relay are open and the third relay is closed. The method further includes determining that the second relay has the adhesion malfunction when a change in the value of the second voltage satisfies a specified condition.

In one aspect, prior to measuring the second voltage across the load multiple times within a specified time period when the first relay and the second relay are open and the third relay is closed, the method further includes measuring a first voltage across the load when the first relay, the second relay, and the third relay each is closed. The method includes determining if a difference between the first voltage and the voltage of the battery pack is greater than a first threshold value prior to measuring the second voltage across the load multiple times within the specified time period when the first relay and the second relay are open and the third relay is closed.

In one aspect, the method further includes determining that the second relay has no adhesion malfunction when the change in the value of the second voltage does not satisfy the specified condition.

In one aspect, after determining that the second relay has an adhesion malfunction, the method further includes outputting a prompt warning message of the adhesion malfunction.

In one aspect, the step of measuring the second voltage across the load multiple times within a specified time period when the first relay and the second relay are open and the third relay is closed includes measuring the second voltage across the load multiple times within the specified time period according to one or more sampling time intervals.

In one aspect, the specified condition includes the condition that a number of instances over the specified time period when a percentage increase in the second voltage measured in two consecutive sampling times exceeds a second threshold value is N, where N is a specified natural number, and that after the specified time period, a ratio of the second voltage to the voltage of the battery pack is greater than a third threshold value.

In one aspect, the difference between the first voltage and the voltage of the battery pack includes a ratio of the first voltage to the voltage of the battery pack, or a difference in the voltages between the first voltage and the voltage of the battery pack.

One or more embodiments of the present invention provides a system configured to detect an adhesion malfunction of a relay. The system may be configured to detect an adhesion malfunction of a relay of a high voltage circuit, where the high voltage circuit comprises a battery pack, a first relay, a load, and a second relay. The first relay is connected to a positive electrode of the battery pack, and the second relay is connected to a negative electrode of the battery pack. The high voltage circuit further includes a series branch formed by a third relay and a first resistor, where the series branch is connected in parallel with the first relay. The system includes an acquiring module that is configured to measure a second voltage across the load multiple times within a specified time period when the first relay and the second relay are open and the third relay is closed. The system also includes a determining module that is configured to determine that the second relay has the adhesion malfunction when a change in the value of the second voltage satisfies a specified condition.

In one aspect, the acquiring module is further configured to measure a first voltage across the load when the first relay, the second relay, and the third relay each is closed.

In one aspect, the acquiring module is further configured to determine that a difference between the first voltage and the voltage of the battery pack is greater than a first threshold value prior to the acquiring module being configured to measure the second voltage across the load multiple times within a specified time period when the first relay and the second relay are open and the third relay is closed.

In one aspect, the system further includes an output module that is configured to output a prompt warning message of an adhesion malfunction.

In one aspect, when the acquiring module is configured to measure a second voltage across the load multiple times within a specified time period when the first relay and the second relay are open and the third relay is closed, the acquiring module is configured to measure the second voltage across the load within the specified time period according to one or more sampling time intervals.

In one aspect, the specified condition includes the condition that a number of instances over the specified time period when a percentage increase in the second voltage measured in two consecutive sampling times exceeds a second threshold value is N, wherein N is a natural number, and that after the specified time period, a ratio of the second voltage to the voltage of the battery pack is greater than a third threshold value.

In one aspect, the difference between the first voltage and the voltage of the battery pack includes a ratio of the first voltage to the voltage of the battery pack, or a difference in the voltages between the first voltage and the voltage of the battery pack.

The one or more embodiments of the present application have the advantages that when the first relay and the second relay are open and the third relay is closed, a determination of whether a change in the value of the second voltage measured across the load within a specified time period meets a specified condition may be used to diagnose whether the second relay has an adhesion issue. In the one or more embodiments of the present application, by measuring the change in the sampled voltages external to the second relay, an adhesion of the second relay can be diagnosed, so that corrective action may be promptly taken. In this way, it may be possible to prevent the potential safety hazard caused by a failure of the high voltage circuit to open in a timely manner due to the adhesion malfunction of the second relay when the second relay has been in prolonged use, thereby improving the safety performance of an electric vehicle using the high voltage circuit.

### BRIEF DESCRIPTION OF THE DRAWINGS

In order to more clearly describe the technical solutions presented in the one or more embodiments of the present application, the drawings for the one or more embodiments are briefly described below. The detailed description set forth below accompanied by the drawings represents only some possible embodiments of the present application. One of ordinary skill in the art may readily modify these accompanying drawings without inventive skills to represent other embodiments of the present application.

FIG. 1 is an exemplary diagram of a high voltage circuit of an electric vehicle.

FIG. 2 is a schematic view of the mechanism for detecting an adhesion of a relay provided in one or more embodiments of the present application.

FIG. 3 is a first exemplary flow chart of a method for detecting an adhesion of a relay provided in one or more embodiments of the present application.

FIG. 4 is a second exemplary flow chart of a method for detecting an adhesion of a relay provided in one or more embodiments of the present application.

FIG. 5 is a third exemplary flow chart of a method for detecting an adhesion of a relay provided in one or more embodiments of the present application.

FIG. 6 is a fourth exemplary flow chart of a method for detecting an adhesion of a relay provided in one or more embodiments of the present application.

FIG. 7 is a functional block diagram of a system for detecting an adhesion of a relay provided in one or more embodiments of the present application.

### DETAILED DESCRIPTION

In order to allow a better understanding of the technical solutions of the present application, embodiments of the present application will be described in detail below with reference to the accompanying drawings. It should be understood that the one or more embodiments described are intended as a description of some embodiments of the application and are not intended to represent all of the embodiments of the present application. Other embodiments may be readily obtained by a person of ordinary skill in the art on the basis of the embodiments described in the present application without inventive skills and all these embodiments still fall within the scope of the present application.

The terms used in the one or more embodiments of the present application are for the purpose of describing certain embodiments only and are not intended to limit the present application. The singular forms of the articles “a,” “an,” and “the,” and others used in the one or more embodiments of the present application and the appended claims are intended to include the plural forms unless the context clearly dictates otherwise.

It is understood that the term “and/or” as used herein is merely for describing the relationship between the associated objects. For examples, “A and/or B” may include the following three combinations: A only, A and B, and B only. In addition, the term “/” in this application generally refers to the associated objects in an “or” relationship.

Depending on the context, the term “if” as used herein may be interpreted as “when,” or “in the case that,” or “in response to a determination,” or “in response to a detection.” Similarly, depending on the context, the phrase “if determined” or “if detected (stated condition or event)” may be interpreted as “when determined,” or “in response to a determination,” or “when detected (stated condition or event),” or “in response to detecting (stated condition or event).”

One or more embodiments of the present application provide a method for detecting an adhesion of a relay. The method for detecting an adhesion of a relay can be implemented using an application (APP). In one aspect, a battery management system (BMS) of an electric vehicle may implement a corresponding function of detecting an adhesion of a relay by installing and running the application.

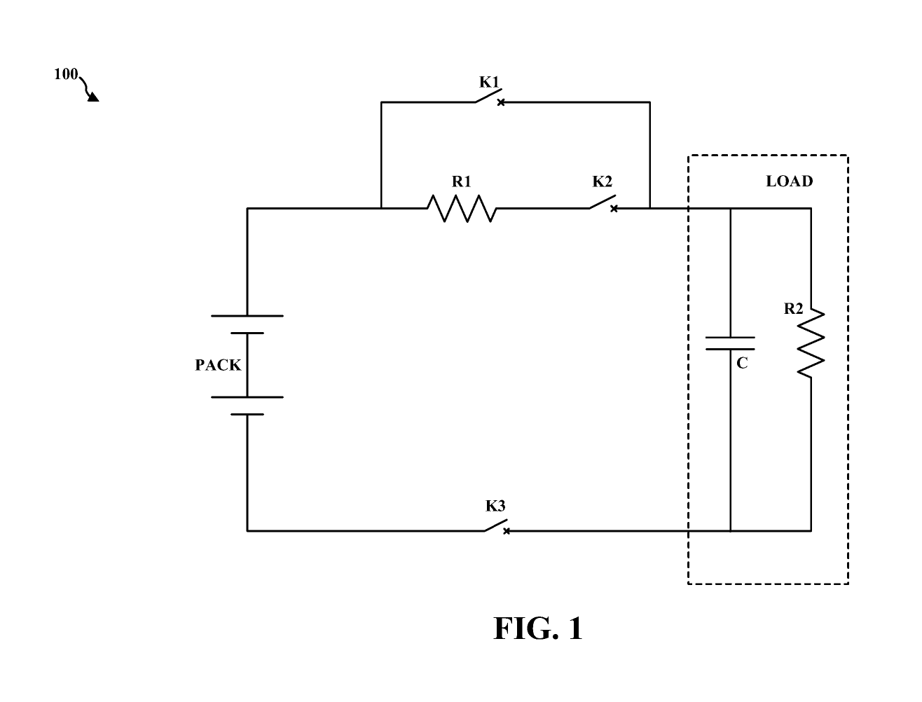

It should be noted that the method for detecting the adhesion of a relay provided by one or more embodiments of the present application may be applied to a high voltage circuit. FIG. 1 is a schematic view of a high voltage circuit in an electric vehicle. In reference to FIG. 1, the high voltage circuit 100 includes a circuit formed by a battery pack PACK, a first relay K1, a load (including a capacitor C and a second resistor R2 connected in parallel with the capacitor C), and a second relay K3. The first relay K1 is connected to a positive electrode of the battery pack PACK having a voltage V, and the second relay K3 is connected to a negative electrode of the battery pack PACK. In FIG. 1, the high voltage circuit 100 further includes a series branch formed by a third relay K2 and a first resistor R1, where the series branch is connected in parallel with the first relay K1. The first relay K1 is a main positive relay, the second relay K3 is a main negative relay, the third relay K2 is a pre-charge relay, and the first resistor R1 is a pre-charge resistor.

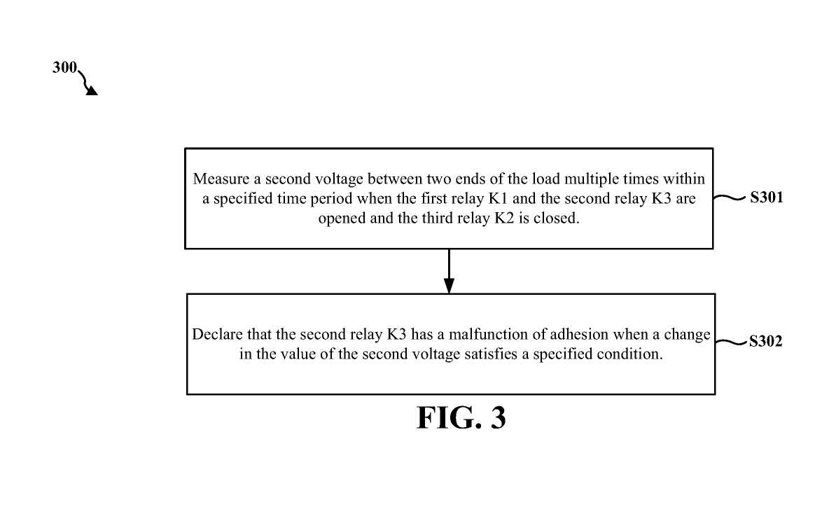

FIG. 3 is a first exemplary flow chart of a method for detecting an adhesion of a relay provided in one or more embodiments of the present application. As shown in FIG. 3, the method 300 for detecting an adhesion of a relay may include the steps or blocks described herein. In block S301, the method measures a second voltage across the load multiple times within a specified time period when the first relay K1 and the second relay K3 are open and the third relay K2 is closed. In block S302, the method declares that the second relay has a malfunction of adhesion when a change in the value of the second voltage satisfies a specified condition. The specified condition may include: 1) the number of instances when a percentage increase in the second voltage measured in two consecutive sampling times exceeds a second threshold value is N over the specified time period, where N is a specified natural number; and 2) after the specified time period, a ratio of the second voltage to the voltage of the battery pack is greater than a third threshold value. In one aspect, the second voltage may be acquired by an acquiring circuit in real time.

As shown in FIG. 3, if the first relay K1 and the second relay K3 are open and the third relay K2 is closed, the method determines whether the change in the value of the second voltage measured across the load multiple times within a specified time period satisfies a specified condition to detect whether the second relay K3 has an adhesion malfunction. Using the change in the sampled voltages external to the second relay K3, an adhesion malfunction of the second relay K3 may be detected and corrective action may be promptly taken. These actions prevent the potential safety hazard caused by a failure of the high voltage circuit 100 to open in a timely manner due to the adhesion malfunction of the second relay K3 when the second relay K3 has been in prolonged use, and improves the safety performance of an electric vehicle using the high voltage circuit 100.

In addition, in an aspect of the embodiment shown in FIG. 3, software may operate on the sampled voltages to determine whether the second relay K3 has an adhesion issue. Thus, there is no need to add extra hardware devices or to increase the complexity and cost of the circuits, keeping the cost low and making the method easy to use.

Moreover, in an aspect of the embodiment shown in FIG. 3, there is no need to measure the voltage from the negative electrode of the battery, allowing the second voltage to be measured by a variety of acquiring circuits. Because many types of chips or acquiring circuits may be used without the complexity associated with trying to measure voltages at the negative electrode, the method has a wide range of applications.

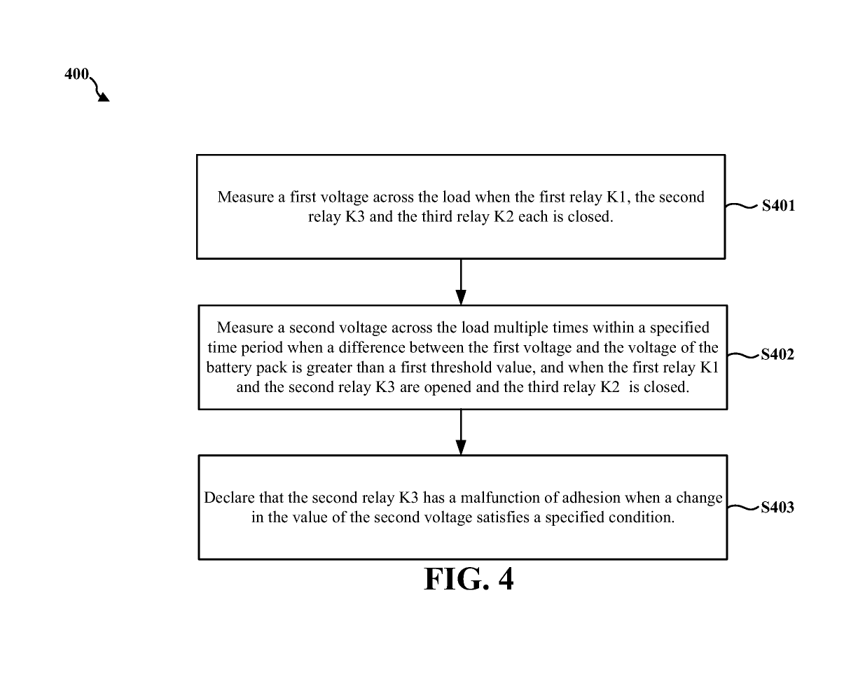

FIG. 4 is a second exemplary flow chart of a method for detecting an adhesion of a relay provided in one or more embodiments of the present application. As shown in FIG. 4, the method 400 for detecting an adhesion of a relay may include the steps or blocks described herein. In block S401, the method measures a first voltage across the load when the first relay K1, the second relay K3 and the third relay K2 each is closed. In block S402, the method performs the following step when a difference between the first voltage and the voltage of the battery pack is greater than a first threshold value: measure a second voltage across the load multiple times within a specified time period when the first relay K1 and the second relay K3 are open and the third relay K2 is closed. In block S403, the method declares that the second relay has a malfunction of adhesion when the change in the value of the second voltage satisfies a specified condition. The first voltage may be acquired by an acquiring circuit in real time.

In block S402, the difference between the first voltage and the voltage of the battery pack may include a ratio of the first voltage to the voltage of the battery pack, or a difference in the voltages between the first voltage and the voltage of the battery pack. In one aspect, when the difference is the ratio of the first voltage to the voltage of the battery pack, the first threshold value may be 50%. In one aspect, determining if the difference between the first voltage and the voltage of the battery pack is greater than a first threshold value may include determining if the ratio of the first voltage to the voltage of the battery pack is less than a threshold such as 50%. In one aspect, when the difference between the first voltage and the voltage of the battery pack is smaller than the first threshold value, the difference between the first voltage and the voltage of the battery pack is relatively small. In such case, even if the second relay K3 has an adhesion malfunction, because the rising time of the second voltage to span the small difference in the voltage may be short, it may not be easy to accurately detect the adhesion of the second relay K3. However, when the difference between the first voltage and the voltage of the battery pack is greater than the first threshold value, the difference between the first voltage and the voltage of the battery pack is relatively large. In such case, when the second relay K3 has an adhesion malfunction, because the rising time of the second voltage to span the larger difference in the voltage is relatively long, it may be easier to accurately detect the adhesion of the second relay K3.

Thus, in the embodiment shown in FIG. 4, when the difference between the first voltage and the voltage of the battery pack is greater than the first threshold value, the method may measure the second voltage. By measuring the change in the value of the second voltage, the method may detect whether the second relay K3 has an adhesion malfunction. Because there may be a longer time to determine an increase in the second voltage than when the difference between the first voltage and the voltage of the battery pack is less than the first threshold value, the method may more accurately determine whether the second relay K3 has an adhesion malfunction.

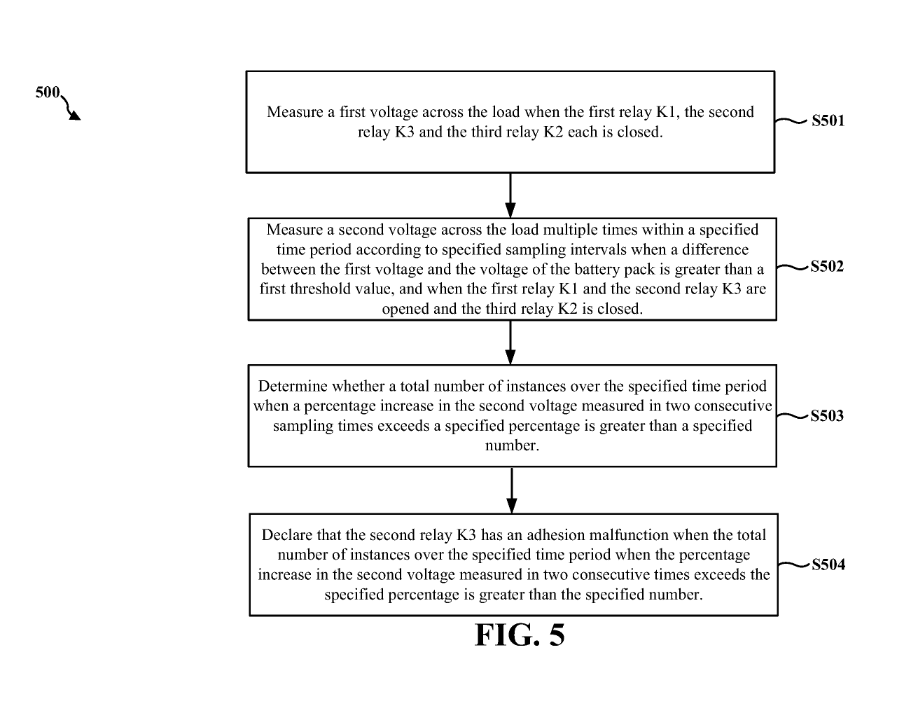

FIG. 5 is a third exemplary flow chart of a method for detecting an adhesion of a relay provided in one or more embodiments of the present application. As shown in FIG. 5, the method 500 for detecting an adhesion of a relay may include the steps described herein. In block S501, the method measures a first voltage across the load when the first relay K1, the second relay K3 and the third relay K2 each is closed. In block S502, the method performs the following step when a difference between the first voltage and the voltage of the battery pack is greater than a first threshold value: measure a second voltage across the load multiple times within a specified time period according to specified sampling intervals when the first relay K1 and the second relay K3 are open and the third relay K2 is closed. In block S03, the method determines whether the total number of instances over the specified time period when a percentage increase in the second voltage measured in two consecutive sampling times exceeds a specified percentage is greater than a specified number. In block S504, the method declares that the second relay K3 has an adhesion malfunction when the total number of instances over the specified time period when the percentage increase in the second voltage measured in two consecutive times exceeds the specified percentage is greater than the specified number.

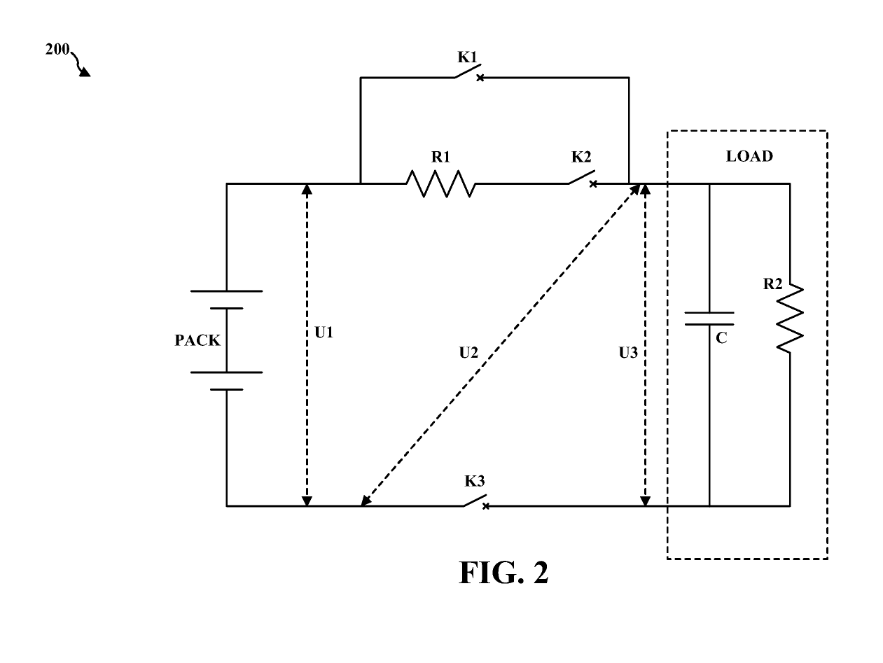

Next, an example will be used to explain the methods described herein in reference to FIG. 2. FIG. 2 is a schematic view 200 of the mechanism for detecting an adhesion of a relay provided in one or more embodiments of the present application. In FIG. 2, the capacitor C may represent the total capacitance of an electric vehicle. In reference to FIG. 2, the voltage U1 is the total voltage of the battery pack PACK. In one aspect, U1 may be 400V. Voltage U2 is the voltage external to the first relay K1. Voltage U3 is the voltage external to the second relay K3, that is, the voltage across the capacitor C (or the voltage across the load). Under normal operating condition (after the vehicle has been working at a high voltage for a period of time), when none of the first relay K1, the third relay K2 and the second relay K3 is closed (that is, they are all open), U1=400V, U2=0V, U3=0V.

Then, the third relay K2 may be closed to measure the change in the voltage U3 (that is, the change of the voltage across the capacitor C). During a 100 ms (millisecond) interval or some other interval, the method may sample the U3 voltage multiple time. The method may determine the difference AU between each currently sampled value of the U3 voltage (e.g., using a sampling period of 10 ms) with its immediately prior sampled value and determines the percentage increase a % of the currently sampled value relative to its immediately prior sampled value (a % is a percentage increase). For example, if the voltages of two consecutively sampled values of the voltage U3 are 100V and 120V respectively, the percentage increase is (120−100)/100=20%. If the number of instances when the percentage increase a % of two consecutively sampled values is greater than 5% (or other thresholds in other examples) reaches 3 (or other numbers) over the 100 ms interval, and the last sampled value of U3 over the 100 ms interval is greater than or equal to 320V (that is, the ratio of U3 to U1 is greater than 80% or other thresholds), the method may declare that the second relay K3 has an adhesion malfunction; otherwise the second relay K3 does not have an adhesion malfunction.

If the number of instances when the percentage increase of consecutively sampled voltages of voltage U3 exceeds 5% reaches 3 (i.e., N=3) over the 100 ms interval, and if the ratio of the voltage U3 to the voltage U1 is greater than 80% after the 100 ms interval, this result may indicate that the sampled voltage values of the voltage U3 external to the second relay K3 are in a “climbing” profile. This climbing profile strongly suggests that the second relay K3 may have an adhesion problem. Therefore, when the sampled voltage external to the second relay K3 shows a “climbing” profile, the method may determine that the second relay K3 has an adhesion malfunction. Under an abnormal operating condition (for example, continuous high and low voltages), the voltage U3 may be close to the voltage U1. In this case, even if the second relay K3 has an adhesion problem, the problem may not be easily detected because the time for the voltage U3 to rise is too short for the “climbing” profile to be detected and for the adhesion problem to be accurately determined.

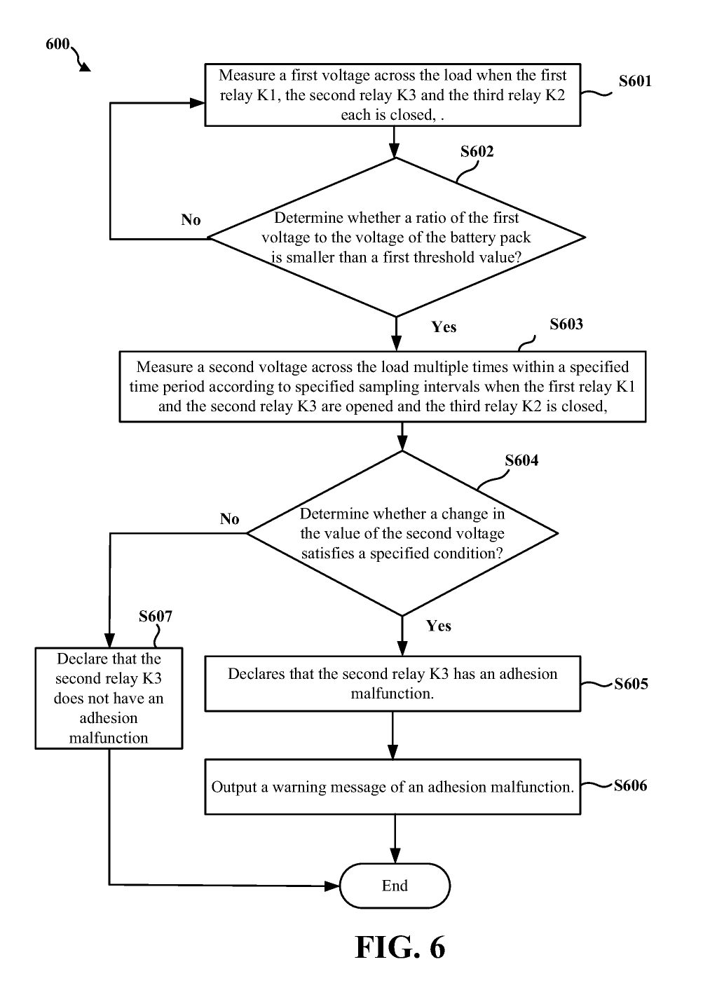

FIG. 6 is a fourth exemplary flow chart of a method for detecting an adhesion of a relay provided in one or more embodiments of the present application. As shown in the FIG. 6, the method 600 for detecting an adhesion of a relay may include the steps described herein. In block S601, the method measures a first voltage across the load when the first relay K1, the second relay K3 and the third relay K2 each is closed. In block S602, the method determines whether a ratio of the first voltage to the voltage of the battery pack is smaller than a first threshold value. If this ratio is smaller than the first threshold value, the method executes block S603, otherwise the method goes back to block S601. In block S603, when the ratio of the first voltage to the voltage of the battery pack is smaller than the first threshold value, the method measures the second voltage across the load multiple times within a specified time period according to specified sampling intervals when the first relay K1 and the second relay K3 are open and the third relay K2 is closed. In block S604, the method determines whether the change in the value of the second voltage satisfies a specified condition. If the change in the value of second voltage satisfies the specified condition, the method executes S605. Otherwise, if the change in the value of the second voltage does not satisfy the specified condition, the method executes S607. In block S605, the method declares that the second relay has an adhesion malfunction. In block S606, the method outputs a prompt warning message of an adhesion malfunction. In block S607, the method determines that the second relay does not have an adhesion malfunction and the method concludes. The warning message of an adhesion malfunction may be an audio or a visual warning signal. For example, in block S606, the method may output the warning message of an adhesion malfunction as a blinking alarm indicator light, an alarm, or other types of audio or visual warning signals.

According to the methods for detecting an adhesion of a relay provided in the one or more embodiments of the present application, when the first relay K1 and the second relay K3 are open and the third relay K2 is closed, the methods determine whether the change in the value of the second voltage measured across the load within a specified time period meets a specified condition to determine whether the second relay has an adhesion malfunction. By measuring the change in the sampled voltages external to the second relay K3, the methods may diagnose if there is an adhesion of the second relay K3 and may take corrective action. In this way, the methods prevent the potential safety hazard caused by a failure of the high voltage circuit 100 to open in a timely manner due to the adhesion malfunction of the second relay K3 when the second relay K3 has been in prolonged use, thereby improving the safety performance of an electric vehicle using the high voltage circuit 100.

The one or more embodiments of the present application further provide a system for detecting an adhesion of a relay. The system for detecting an adhesion of a relay may implement the blocks of the relay adhesion detection methods provided in the embodiments disclosed herein.

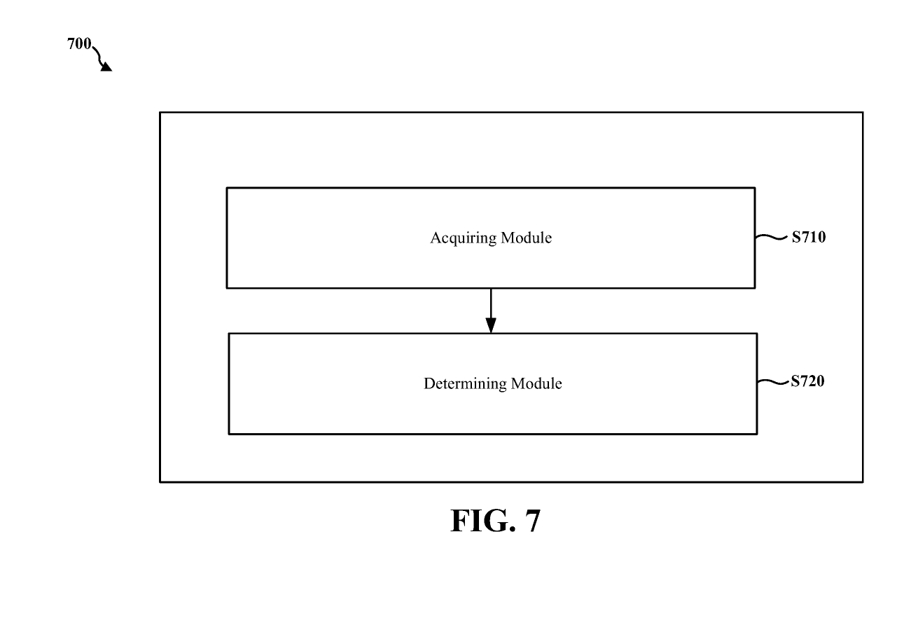

FIG. 7 is a functional block diagram of a system 700 configured to detect an adhesion of a relay provided in one or more embodiments of the present application. The system 700 may operate on a high voltage circuit 100 of FIG. 1. As shown in FIG. 1, the high voltage circuit 100 may include a battery pack, a first relay K1, a load, and a second relay K3. The first relay K1 is connected to a positive electrode of the battery pack, and the second relay K3 is connected to a negative electrode of the battery pack. The high voltage circuit 100 further includes a series branch formed by a third relay K2 and a first resistor R1, where the series branch is connected in parallel with the first relay K1.

As shown in FIG. 7, the system 700 configured to detect an adhesion of a relay may include an acquiring module 710 and a determining module 720. The acquiring module 710 may be configured to measure a second voltage across the load multiple times within a specified time period when the first relay K1 and the second relay K3 are open and the third relay K2 is closed. The determining module 720 may be configured to determine that the second relay has an adhesion malfunction when a change in the value of the second voltage satisfies a specified condition.

In one aspect, the acquiring module 710 may be configured to acquire a first voltage across the load when the first relay K1, the second relay K3, and the third relay K2 each is closed. In one aspect, the acquiring module 710 may be further configured to perform the following step when a difference between the first voltage and the voltage of the battery pack is greater than a first threshold value: measure the second voltages across the load multiple times within the specified time period when the first relay K1 and the second relay K3 are open and the third relay K2 is closed. In one aspect, the acquiring module 710 may be configured to measure the second voltage across the load multiple times within the specified time period according to specified sampling intervals when the first relay and the second relay are open and the third relay is closed. In one configuration, the acquiring module 710 may be implemented in an acquiring circuit, and the determining module 720 may be implemented in a battery management system (BMS).

In one aspect, the determining module 720 maybe further configured to determine that the second relay does not have an adhesion malfunction when the change in the value of the second voltage does not satisfy a specified condition. In one configuration, the system 700 configured to detect an adhesion of a relay may further include an output module, which may be configured to output a prompt warning message of an adhesion malfunction.

In one aspect, the specified condition to be satisfied by the change in the value of the second voltage may include: 1) the number of instances when a percentage increase in the second voltage measured in two consecutive sampling times exceeds a second threshold value is N during the specified time period, where N is a specified natural number; and 2) after the specified time period, a ratio of the second voltage to the voltage of the battery pack is greater than a third threshold value.

In one aspect, when the acquiring module 710 is configured to determine that a difference between the first voltage and the voltage of the battery pack is greater than a first threshold value, the difference may include a ratio of the first voltage to the voltage of the battery pack. In one aspect, the difference may be a difference in the voltages between the first voltage and the voltage of the battery pack. In one aspect, if the difference is the ratio of the first voltage to the voltage of the battery pack, the first threshold value may be 50%. In one aspect, the acquiring module 710 may be configured to determine if the ratio of the first voltage to the voltage of the battery pack is less than 50% to determine if a difference between the first voltage and the voltage of the battery pack is greater than a first threshold value.

The relay adhesion detection system 700 described in this embodiment of the application may implement the methods for detecting the adhesion of the relay in the embodiments disclosed in FIGS. 3-6. For any part of the adhesion detection system 700 not described in detail in this embodiment, reference may be made to the description for the methods for detecting the adhesion of the relay provided in the embodiments of FIGS. 3-6.

According to the systems for detecting an adhesion of a relay provided in the embodiments of the present application, when the first relay K1 and the second relay K3 are open and the third relay K2 is closed, the systems are configured to determine whether the change in the value of the second voltage measured across the load within a specified time period meets a specified condition to determine whether the second relay has an adhesion issue. By measuring the change in the sampled voltages external to the second relay K3, the systems may diagnose if there is an adhesion malfunction of the second relay K3, and may take corrective action. In this way, the systems may prevent the potential safety hazard caused by a failure of the high voltage circuit 100 to open in a timely manner due to the adhesion malfunction of the second relay K3 when the second relay K3 has been in prolonged use, thereby improving the safety performance of an electric vehicle using the high voltage circuit 100.

For clarity of description so as not to obscure the inventive concept, some components, devices, units, and steps of the systems and methods of the embodiments of the present application are not described in detail. It is understood that such details are within the knowledge of one of ordinary skill in the art and the detailed description and the accompanying figures of the embodiments of the application disclosed herein fully enable one of ordinary skill in the art to practice the technical solution of the present application.

Disclosed are several exemplary embodiments of the present application. It should be understood that the disclosed systems, devices, and methods may be implemented in other configurations. For example, the division of the systems and methods of the exemplary embodiments into the various functional blocks, components, and steps presented herein is merely one logical functional division and there may be other division(s) for other configurations. For example, multiple units, components, blocks, or steps may be combined, one of them may be integrated into another one, or some of the components may be disabled or steps not executed. In addition, any described mutual coupling, direct coupling, or communication link may be an indirect coupling or a communication link connected through other interfaces, devices or units, and may be implemented in electrical, mechanical or other forms.

Units described as separate components may or may not be physically separate. Components displayed as one unit may or may not be located in one physical unit. That is, a unit may be located in one place or may be distributed across multiple network units. Some or all of the units may be selected according to actual needs to achieve the objective of the systems or methods in one or more embodiments. In addition, multiple functional units in one embodiment may be integrated into one processing unit; each functional unit may exist as separate physical units; or two or more units may be integrated in one unit. A functional unit or an integrated unit may be implemented in hardware, or in hardware plus software.

Disclosed above are exemplary embodiments of the present application, and the disclosed embodiments are not intended to limit the present application. To one of ordinary skill in the art, the present application may include various changes and modification. Any modifications, replacements, or improvements made within the spirit and principle of the present application should be encompassed within the scope of the present application.

What is claimed is:

1. A method for detecting an adhesion malfunction of a relay of a high voltage circuit, the high voltage circuit comprising a battery pack, a first relay, a load, a series branch, and a second relay, wherein the first relay is connected to a positive electrode of the battery pack, the second relay is connected to a negative electrode of the battery pack, the series branch includes a third relay and a first resistor, and wherein the series branch is connected in parallel with the first relay, the method comprising:
measuring a second voltage across the load multiple times within a time period when the first relay and the second relay are open and the third relay is closed; and
determining that the second relay has the adhesion malfunction when a change in a value of the second voltage satisfies a condition.

2. The method according to claim 1, further comprising:
measuring a first voltage across the load when the first relay, the second relay, and the third relay each is closed; and
determining that a difference between the first voltage and a voltage of the battery pack is greater than a first threshold value as a precondition to measuring the second voltage.

3. The method according to claim 1, further comprising:
determining that the second relay does not have the adhesion malfunction when the change in the value of the second voltage does not satisfy the condition.

4. The method according to claim 1, further comprising:
outputting a warning message of the adhesion malfunction after the second relay has the adhesion malfunction.

5. The method according to claim 1, wherein measuring the second voltage across the load multiple times within the specified time period comprises measuring the second voltage across the load according to one or more sampling time intervals.

6. The method according to claim 1, wherein the condition comprises:
a number of instances over the time period when a percentage increase in the second voltage measured in two consecutive sampling times exceeds a second threshold value is N, wherein N is a natural number; and
after the time period, a ratio of a measured second voltage to the voltage of the battery pack is greater than a third threshold value.

7. The method according to claim 2, wherein the difference between the first voltage and the voltage of the battery pack comprises a ratio of the first voltage to the voltage of the battery pack or a difference in voltages between the first voltage and the voltage of the battery pack.

8. A system configured to detect an adhesion malfunction of a relay of a high voltage circuit, the high voltage circuit comprising a battery pack, a first relay, a load, a series branch, and a second relay, wherein the first relay is connected to a positive electrode of the battery pack, the second relay is connected to a negative electrode of the battery pack, the series branch includes a third relay and a first resistor, and wherein the series branch is connected in parallel with the first relay, the system comprising:
an acquiring module configured to measure a second voltage across the load multiple times within a time period when the first relay and the second relay are open and the third relay is closed; and
a determining module configured to determine that the second relay has the adhesion malfunction when a change in a value of the second voltage satisfies a condition.

9. The system according to claim 8, wherein the acquiring module is further configured to measure a first voltage across the load when the first relay, the second relay, and the third relay each is closed.

10. The system according to claim 9, wherein the acquiring module is further configured to determine that a difference between the first voltage and a voltage of the battery pack is greater than a first threshold value as a precondition to the acquiring module being configured to measure the second voltage.

11. The system according to claim 8, wherein the system further comprises:
an output module configured to output a warning message of the adhesion malfunction.

12. The system according to claim 8, wherein the acquiring module is configured to measure the second voltage across the load multiple times within the time period comprises the acquiring module is configured to measure the second voltage across the load according to one or more sampling time intervals.

13. The system according to claim 8, wherein the condition comprises:
a number of instances over the time period when a percentage increase in the second voltage measured in two consecutive sampling times exceeds a second threshold value is N, wherein N is a natural number; and
after the time period, a ratio of a measured second voltage to the voltage of the battery pack is greater than a third threshold value.

14. The system according to claim 10, wherein the difference between the first voltage and the voltage of the battery pack comprises a ratio of the first voltage to the voltage of the battery pack or a difference in voltages between the first voltage and the voltage of the battery pack.
